(19) United States
(12) Patent Application Publication
(10) Pub. No.: US 2011/0247472 A1
(43) Pub. Date: Oct. 13, 2011

(54) BANDWHEEL AND BLADE BRAKE SYSTEM

(75) Inventor: Peter DALE, Kilworthy (CA)

(73) Assignee: NORWOOD INDUSTRIES, INC., Kilworthy (CA)

(21) Appl. No.: 13/083,067

(22) Filed: Apr. 8, 2011

(30) Foreign Application Priority Data
Apr. 8, 2010 (CA) 2,696,974

(51) Int. Cl. B27B 13/14

(52) U.S. Cl. 83/788

(57) ABSTRACT

The present invention relates to a belt brake for a band saw such as a band saw on a sawmill utilized for sawing lumber. The belt brake provides added safety by stopping the blade of the band saw when the operator deactivates the band saw, for example, by turning the band saw off or operating the band saw clutch. The belt brake activation may be synchronized with the band saw's clutch mechanism.

### FIELD OF THE INVENTION

The present invention relates to a belt brake for a band saw such as a band saw on a sawmill utilized for sawing lumber.

### BACKGROUND OF THE INVENTION

A conventional band saw is often used in sawmills. Such a band saw typically has a relatively large, circular, endless band saw blade, mounted along the path of travel of wood placed on a suitable moving bed with a drive mechanism for advancing the wood against the blade. Alternatively, the wood remains stationary and the band saw is mounted on a carriage which is capable of transverse displacement along the wood.

The blade moves in a generally circular path, typically around two rotating coplanar band wheels, one of which is powered by a motor, either via direct drive or a belt drive. The second band wheel rotates under the force transmitted through the movement of the blade. In the case of a belt drive, a tensioning pulley may provide variable tension to the belt so that an operator can activate or deactivate the rotation of the blade by adjusting tension on the tensioning pulley, rather than starting or stopping the motor. This method creates much less wear on the motor and belt. Often the tensioning pulley is adjusted by means of a clutch.

One problem with such a method, however, is that when the tension on the belt is decreased, though the blade eventually comes to a stop, entropy from the large and heavy band wheels results in continued rotation for a fairly long time before the blade stops completely. This creates a safety issue for the user, since the user may deactivate the band saw and forget that it is still in motion. This safety issue is exacerbated by the fact that the sound from the motor may change when the clutch is activated.

There are several prior inventions for band saws.

U.S. Pat. No. 4,275,632 describes a portable sawmill comprising a U-shaped support or carriage, holding a band saw. Canadian Patent No. 1,200,180 describes a portable sawmill having a band saw on a carriage. The LumberMate™ band sawmill (Canadian Patent No 2,488,216 and Canadian Industrial Design Application no. 132823) is a portable sawmill having a band saw with a circular band saw blade which rotates around two band saw wheels.

There is a need for an improved band saw having a brake assembly for stopping the blade of the band saw when it is deactivated by a user.

### SUMMARY OF THE INVENTION

According to one aspect of the invention is provided a band saw having1. A band saw having: an endless saw blade driven around a first band wheel and a coplanar second band wheel configured to provide a cutting area between the first band wheel and the second band wheel; a motor for driving the saw blade; the motor providing rotational force to drive a band wheel; further characterized such that: the band saw comprises a brake belt, the brake belt having a first end, a second end, and a belt surface between the first end and the second end, the brake belt being configured such that a portion of the belt surface travels along a brake wheel connected to the first band wheel or the second band wheel; at least one of the first end and second end being displaceable such that the brake belt has a first, tense position which provides frictional force to the brake wheel, and a second, loose position which provides significantly less or no frictional force to the brake wheel.

In certain embodiments, the brake belt is biased towards the first, tense position.

In certain embodiments, the brake belt can be displaced from the first, tense position to the second, loose position by a user.

In yet further embodiments, the displacing of the first and/or second end of the brake belt and the moving of the tensioning pulley is synchronized.

In yet further embodiments, when the tensioning pulley is in the first, disengaged position, the brake belt is in the first, tense position, and when the tensioning pulley is in the second, engaged position the brake belt is in the second, loose position.

In yet further embodiments, wherein the tensioning pulley is connected to a clutch handle by means of a Bowden cable, which is capable of displacing a pivoting clutch assembly on which the tensioning pulley is mounted.

In yet further embodiments, the first end and/or the second end of the brake belt is connected to the pivoting clutch assembly.

### BRIEF DESCRIPTION OF THE DRAWINGS

FIG. 1 is a front perspective view of a band saw according to one aspect of the present invention, with the protective cover off so that the internal components can be viewed, and is labeled with its major components.

FIG. 2 is a line drawing, right angled view of the band saw of FIG. 1.

FIG. 3 is a line drawing, left angled view of the band saw head of FIG. 1.

FIG. 4 is close-up front perspective view of the clutch and brake mechanism of the band saw of FIG. 1.

FIG. 5 is a photograph of the clutch and brake mechanism of the band saw of FIG. 4.

FIGS. 6-9 are various close-up photographic views of the band saw of FIG. 5.

### DETAILED DESCRIPTION OF THE PREFERRED EMBODIMENTS

The present invention provides a simple and effective adjustable band brake for a band saw. As shown (but optionally), the band brake is integrated into a clutch mechanism of a band-driven band saw.

The band brake provides braking action on the band saw blade. Without such a brake, the bandwheels and blade would continue rotating for a prolonged period of time, notwithstanding that the operator has released the engine throttle to idle. The band brake provides an effective, reliable and low cost solution in a manner that can fit within the very narrow confines of the bandwheel guard housing.

The brake provides substantial safety over a non-braking band saw. As set out below, the brake can be configured such that it is automatically engaged upon release of the engine throttle.

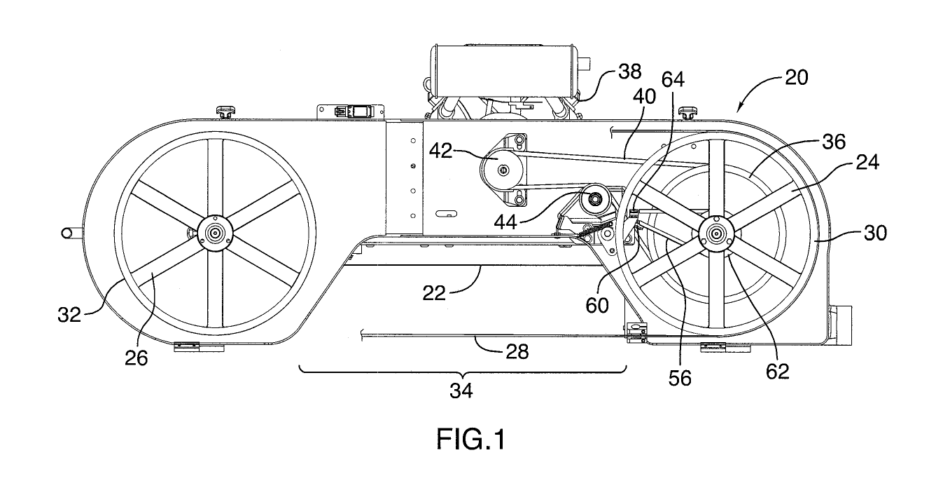

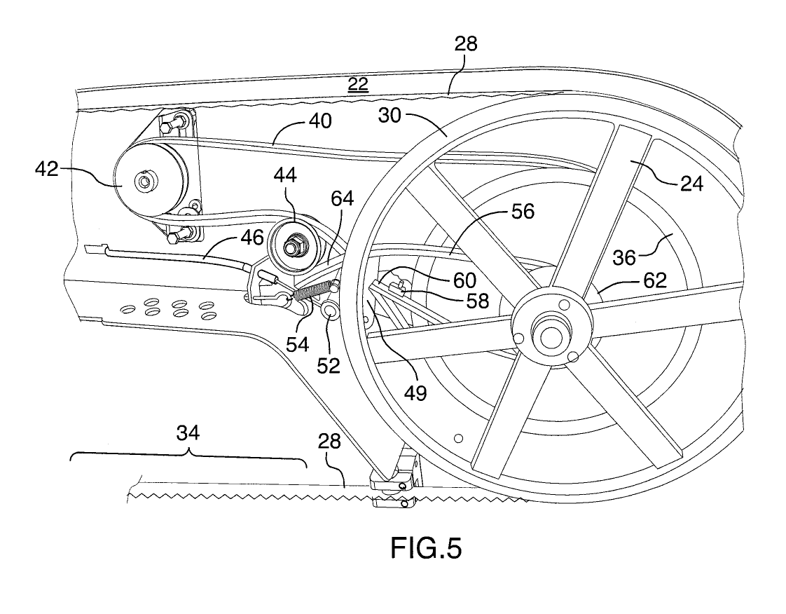

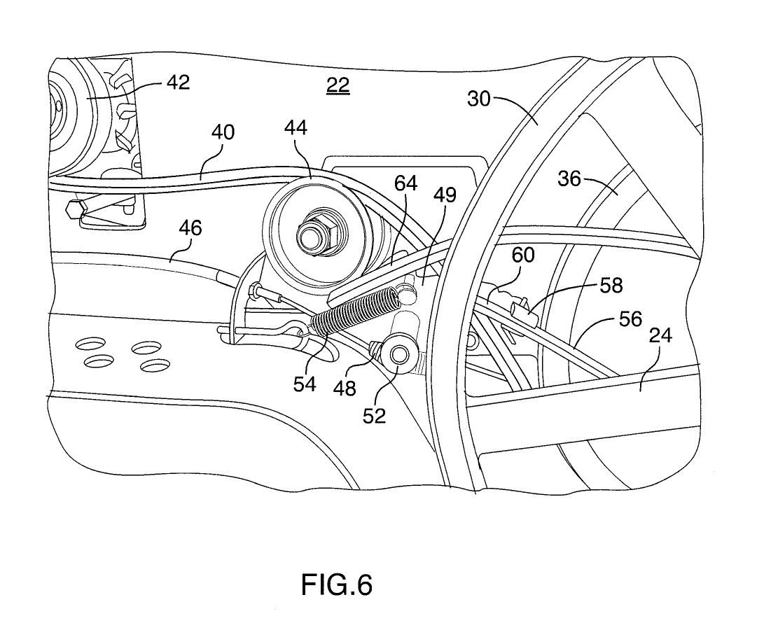

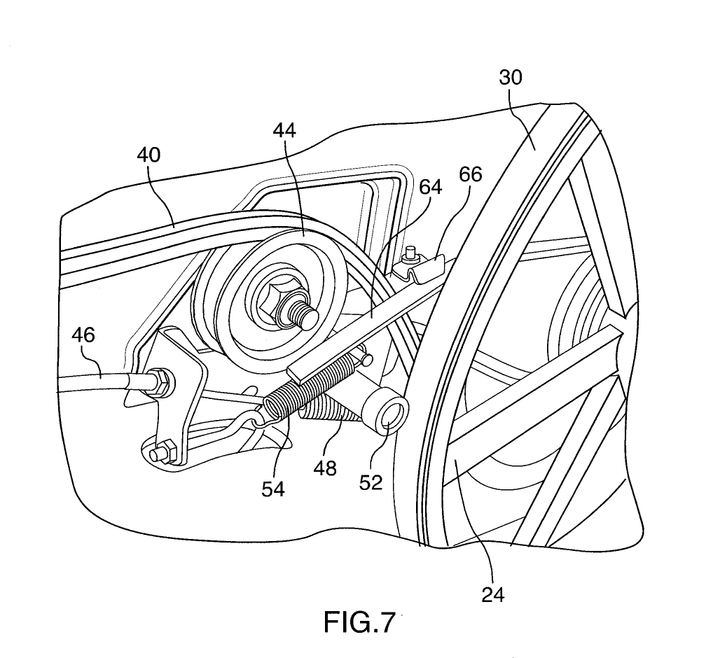

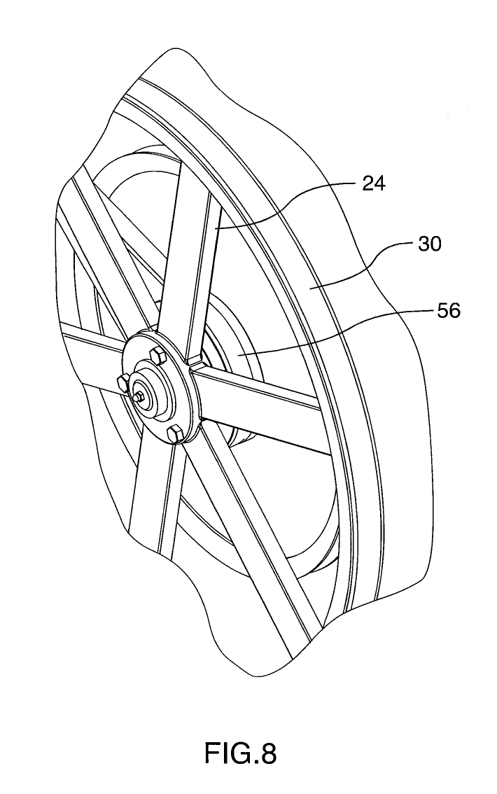

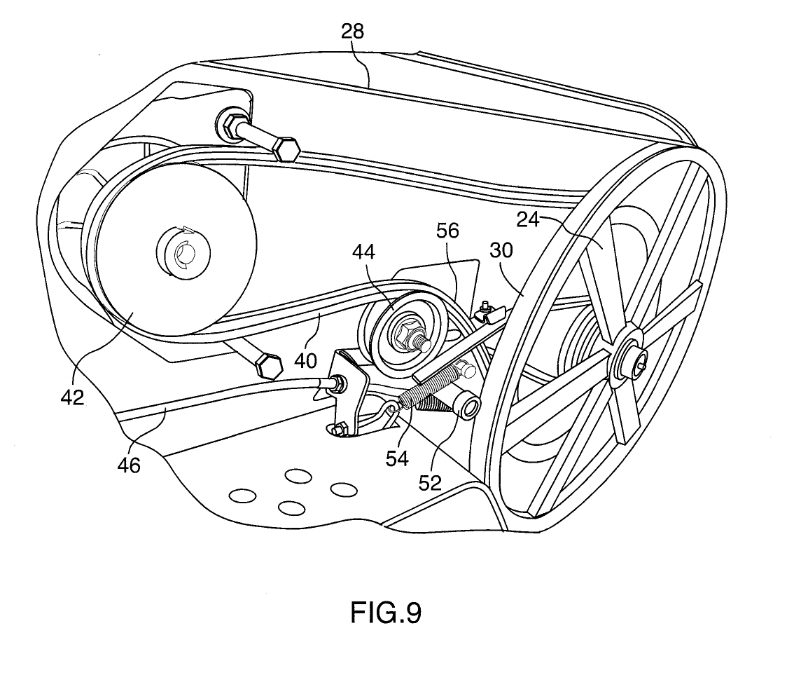

An embodiment of the present invention will now be described as shown in FIGS. 1-9.

As seen in FIG. 1, band saw 20 has a saw head plate stack 22 which acts as support for drive band wheel 24 and free band wheel 26, which are coplanar. Not shown is a front cover (guard housing) for the band saw, which would cover the inner workings of the band saw and act as a safety barrier. Band saw blade 28 is entrained on and travels along outer wheel 30, 32 of drive band wheel 22 and free wheel 24, respectively, and travels along cutting section 34, located between the drive band wheel 24 and free band wheel 26. Band saw blade 28 has transversely extending teeth capable, when in motion, of cutting wood. An inner wheel 36 of drive band wheel 24 is connected to a motor 38 by way of drive belt 40 which runs along inner wheel 36 and drive pulley 42. Tension on drive belt 40 is controlled by way of tensioning pulley 44. In use, motor 38 turns drive pulley 42, which, in turn, turns drive band wheel 24 and, as a result, saw blade 28, which rotates around drive band wheel 24 and free band wheel 26. The free band wheel 26 rotates under the force transmitted through the movement of the saw blade 28.

Tensioning pulley 44 can also be used as a clutch for the saw blade 28; instead of continuously shutting off and turning on the motor 38 to activate the cutting action of saw blade 28, tension can be released from drive belt 40 by adjusting tensioning pulley 44. Releasing tension in drive belt 40 results in the free spinning of drive pulley 42 and a decrease of rotatory force on saw blade 38, resulting in the stopping of the saw blade 38. Starting and stopping saw blade 38 in this manner decreases wear on motor 38 and drive belt 40, improving the longevity of these parts. However, starting and stopping saw blade 38 in this manner, without a brake, would result in the free spinning of saw blade 38 before it eventually comes to a stop once the entropy of the saw blade 38 and the band wheels 24, 26 is dispersed.

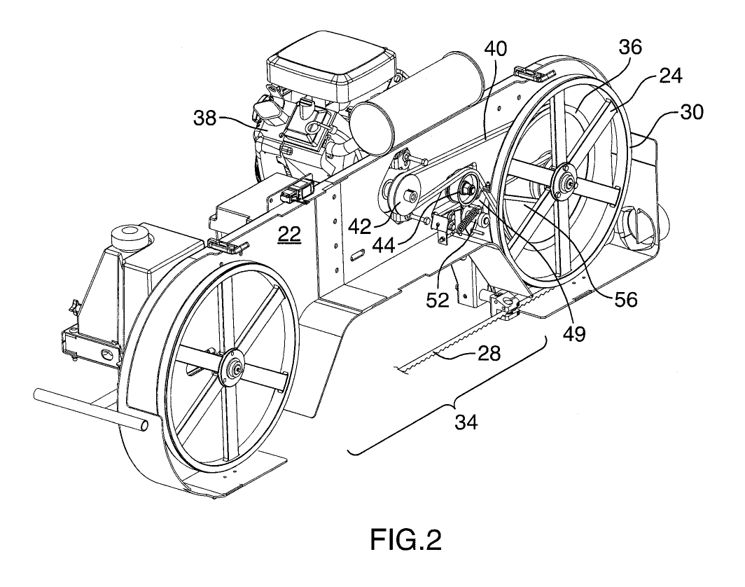

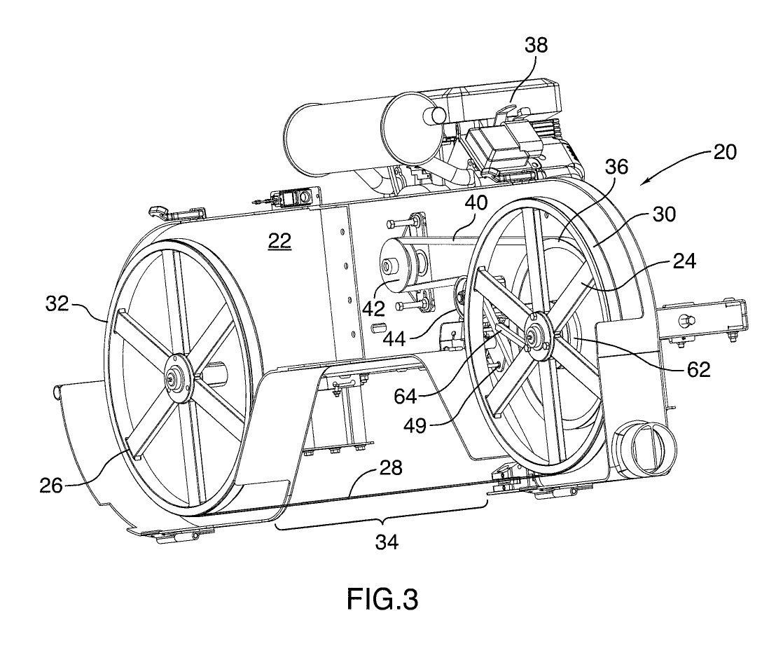

As seen in FIGS. 2 and 3, tensioning pulley 44 is controlled by a user through pivoting clutch assembly 49. As shown, a clutch cable 46 is a Bowden cable with a fixed hollow outer cable housing and a displaceable inner cable. When the user operates a clutch handle (not shown), typically by squeezing a trigger (not shown), it displaces the inner cable, which is connected through clutch post 50 to clutch pivoting assembly 49. The clutch pivoting assembly 49 rotates around clutch pivot 52, and is biased in one direction through clutch spring 54. Thus, when the clutch handle (not shown) is displaced by the user (activated), the clutch pivoting assembly 49 rotates to a second position so that tensioning pulley 44 provides tension to drive belt 40, causing the rotation of the drive band wheel 24, and as a result, the rotation of the blade 28 and the free band wheel 26, through the rotatory force of the motor 38 through the drive pulley 42. When the clutch handle (not shown) is deactivated (for example, released by the user), the clutch pivoting assembly 49 rotates back to a first position such that tensioning pulley 44 no longer provides sufficient tension to the drive belt 40 to cause rotation of the drive band wheel 24. Clutch pivoting assembly 49 rotates back to this position due to biasing means in the form of clutch spring 54.

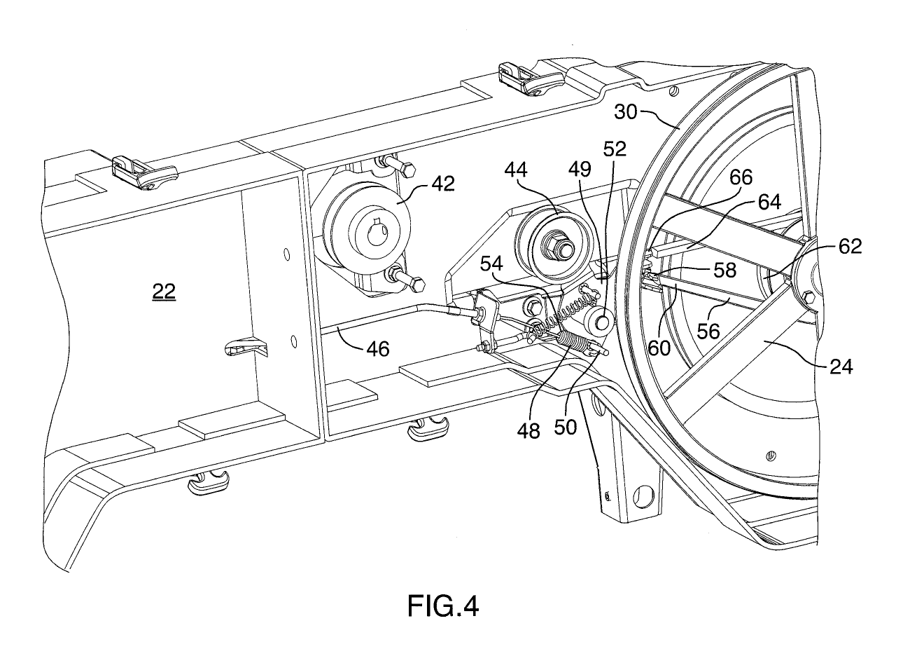

The brake assembly is shown in FIGS. 4 to 9. A brake belt 56 is attached at a first or fixed end 60 by bake belt clamp 58, which acts as an anchor point. The brake belt 56 has a belt surface which travels along a brake wheel 62 connected to drive band wheel 24, and is attached at its second or movable end 64 to second brake belt clamp 66. Second brake belt clamp 66 is connected to pivoting assembly 49 such that, when pivoting assembly 49 is in its second position, the brake belt 56 is pulled to a taught position which provides frictional resistance between belt surface and brake wheel 62 sufficient to quickly slow down and stop the drive band wheel 24 and, as a result, the band saw blade 28. As the user engages or activates the clutch handle, clutch pivoting assembly 49 rotates to the second position, providing tension to the drive belt 40 as discussed above, but also displacing the second end of brake belt 64 towards the brake wheel 62, which adds slack to the brake belt 56, removes frictional tension from drive band wheel 24 at brake wheel 62, thus deactivating the brake.

Thus, in this manner, presently provided is a simple and efficient braking mechanism for a band saw, whereby the clutch mechanism is combined with the braking mechanism. The braking mechanism allows reliable and cost effective braking in a manner that can fit within the very narrow confines of the bandwheel guard housing.

As would be understood by a person of skill in the art, the provided embodiment can be modified for specific needs. For example, in some applications, both of the ends of the brake belt can be attached to the pivoting assembly, to provide additional frictional force on the brake wheel 62, or where it is desired to provide more uniform braking force. In other applications, the brake belt can be attached to a second, separate pivoting assembly, operated for example by a second Bowden cable. This can be useful where a different amount of displacement is required for the brake belt as compared to the tensioning pulley, or, for example, where a different biasing strength is needed. The second Bowden cable can be attached to the clutch handle, or, alternatively, may be attached to a separate brake handle, for operation of the brake separately from the clutch. In certain other embodiments, depending on the desired configuration and the design limitations of the specific band saw, the brake belt can travel along a brake wheel on the free band wheel instead of on the drive band wheel.

It is to be understood that the present invention is not limited to the embodiments described above, but encompasses any and all embodiments within the scope of the following claims.

### Element List

20 bandsaw
22 sawhead plate stack
24 drive band wheel
26 free band wheel
28 band saw blade
30 outer drive band wheel
32 outer free band wheel
34 cutting section
36 inner drive band wheel
38 motor
40 drive belt
42 drive pulley
44 tensioning pulley
46 clutch cable
48 clip
49 pivoting assembly
50 clutch post
52 clutch pivot
54 clutch spring
56 brake belt
58 brake belt clamp (fixed anchor point)
60 first or fixed end of brake belt
62 brake wheel
64 second, or movable end of brake belt
66 brake belt clamp (movable anchor point)

1. A band saw having:
an endless saw blade driven around a first band wheel and a coplanar second band wheel configured to provide a cutting area between said first band wheel and said second band wheel;
a motor for driving said saw blade;
said motor providing rotational force to drive a band wheel;
further characterized such that:
the band saw comprises a brake belt, said brake belt having a first end, a second end, and a belt surface between said first end and said second end, said brake belt being configured such that a portion of said belt surface travels along a brake wheel connected to the first band wheel or the second band wheel;
at least one of said first end and second end being displaceable such that the brake belt has a first, tense position which provides frictional force to the brake wheel, and a second, loose position which provides significantly less or no frictional force to the brake wheel.

2. The band saw of claim 1, wherein the brake belt is biased towards the first, tense position.

3. The band saw of claim 1, wherein the brake wheel is on an axis connected to the first band wheel.

4. The band saw of claim 1, wherein the displacing of the first and/or second end of the brake belt is synchronized with the movement of a tensioning pulley.

5. The band saw of claim 1, wherein a drive belt provides rotational force and drives the first band wheel,
a tensioning pulley provides tension to the drive belt and has a first, disengaged position and a second, engaged position whereby, when the tensioning pulley is in the second, engaged position, it provides sufficient tension so that sufficient rotational force is transferred from the motor to the first band wheel to significantly rotate the first band wheel, and, when the tensioning pulley is in the first, disengaged position, it provides insufficient tension so that insufficient rotational force is transferred from the motor to the drive belt to significantly rotate the first band wheel;
and wherein said tensioning pulley is biased towards the first, disengaged position and movable from said first, disengaged position to the second, engaged position by a user;
and when the tensioning pulley is in the first, disengaged position, the brake belt is in the first, tense position, and when the tensioning pulley is in the second, engaged position the brake belt is in the second, loose position.

6. The band saw of claim 5, wherein the tensioning pulley is connected to a clutch handle by means of a cable, which is capable of displacing a pivoting clutch assembly on which the tensioning pulley is mounted.

7. The band saw of claim 6, wherein the first end and/or the second end of the brake belt is connected to the pivoting clutch assembly.

8. The band saw of claim 6, wherein the clutch assembly is a pivoting clutch assembly.

9. The band saw of claim 6, wherein the cable is a Bowden cable.

10. The band saw of claim 2, wherein the brake belt is biased with a spring.

11. The band saw of claim 5, wherein the drive belt is biased with a spring.
